(19) United States
(12) Patent Application Publication
(10) Pub. No.: US 2023/0062645 A1
(43) Pub. Date: Mar. 2, 2023

(54) PARALLEL INSTRUCTION EXTRACTION METHOD AND READABLE STORAGE MEDIUM

(71) Applicant: Guangdong StarFive Technology Co., Ltd., Foshan (CN)

(72) Inventors: Quansheng Liu, Shanghai (CN); Hongbin Yu, Beijing (CN); Lei Liu, Beijing (CN)

(73) Assignee: Guangdong StarFive Technology Co., Ltd., Foshan (CN)

(21) Appl. No.: 17/981,336

(22) Filed: Nov. 4, 2022

Related U.S. Application Data
(63) Continuation of application No. PCT/CN2021/129451, filed on Nov. 9, 2021.

(30) Foreign Application Priority Data
Dec. 16, 2020 (CN) 202011482353.1

(51) Int. Cl. G06F 9/38; G06F 9/30

(52) U.S. Cl. CPC G06F 9/3804; G06F 9/30145; G06F 9/30047

(57) ABSTRACT

The invention relates to the technical field of a processor, in particular to a method for parallel extracting instructions and a readable storage medium. The method generates a valid vector of fetched instructions according to the end position vector s_mark_end of the instruction, and performs parallel decoding of instructions at each position, calculation of instruction address and branch instruction target address operation through logical “AND” and logical “OR” operations. Ultimately, multiple instructions are fetched in parallel. The present invention is a method for generating a valid vector of fetching instructions according to the end position vector s_mark_end of the instruction, and extracting multiple instructions in parallel through logical “AND” and logical “OR” operations. The invention can extract a plurality of instructions in parallel, there is no serial dependence relationship between each instruction, and the time sequence is easy to converge, so a higher main frequency can be obtained.

### TECHNICAL FIELD

The present invention relates to the technical field of processors, in particular to a method for extracting instructions in parallel and a readable storage medium.

### BACKGROUND TECHNOLOGY

After more than 50 years of development, the architecture of microprocessor has experienced vigorous development along with the semiconductor technology, from single-core to physical multi-core and logical multi-core; from sequential execution to out-of-order execution; from single-issue to multi-issue. Especially in the server field, the performance of the processor is constantly being pursued.

At present, server chips are basically superscalar out-of-order execution architecture, and the processing bandwidth of processors is getting higher and higher, up to 8 or more instructions per clock cycle.

When multiple instructions are fetched at the same time in the instruction fetch unit, each instruction is fetched in sequence, and the logical link is relatively long. At present, high-performance processors need to extract 8 or more bandwidths per clock cycle, and the clock frequency requirements are relatively high. The current implementation method does not meet the requirements.

### SUMMARY OF THE INVENTION

In view of the deficiency of the prior art, the invention discloses a parallel extraction instruction method and a readable storage medium, which is used for solving the problem that when Instruction Fetch Unit fetches multiple instructions at the same time, the logical link of serial extraction of each instruction is relatively long. At present, high-performance processors need to extract 8 or more bandwidth per clock cycle, and the clock frequency is relatively high. The current implementation method can not meet the requirements.

The present invention is achieved through the following technical solutions:

First, the invention discloses a method for parallel extracting instructions, which is characterized in that the method generates the effective vector of the extracted instruction according to the end position vector s_mark_end of the instruction, performs parallel decoding of instructions at each position through logical “AND” and logical “OR” operations, calculates the instruction address and the branch instruction target address operation, and finally fetches multiple instructions in parallel.

Further, in the method, the low 2 bit of the first instruction is first determined. If the low 2 bit is 00, 01, or 10:00, the first instruction length is 16 bit, and if the low 2 bit is 11:00, then the first instruction length is 32 bit. Then the second instruction is judged from the next byte at the end position of the instruction. The judgment process is similar to that of the first instruction, and the length of the second instruction is obtained. By analogy, the length of each instruction in cacheline is obtained. After obtaining the length of each instruction, the end position vector s_end_mark of each instruction in the instruction stream is obtained.

Further, in the method, when an instruction is written, the end position vector s_end_mark of each instruction is calculated, and the instruction returned from the writer is in cacheline units. Each cacheline is 64 byte. The high and low 32 byte of the instruction calculates the end position vector of the instruction respectively, and the high 32 byte instruction speculates that the instruction end position vector s_end_mark_0 and s_end_mark_1 with offset 0 and offset 2. According to the low 32 byte instruction end position vector, a high 32 byte vector is selected as the final instruction end vector of the high 32 byte instruction. The instruction end position vector and the instruction are written at the same time.

Further, in the method, when the Instruction Fetch Unit starts fetching fingers, the read instruction simultaneously reads the instruction end position vector to verify the prediction information of the BPU and extract the instruction. The instruction end position vector s_mark_end indicates whether the position is the end position of an instruction, a value of 1 means the end position of an instruction, and a value of 0 indicates the end position of an instruction.

Further, in the method, the bandwidth of the Instruction Fetch Unit is each clock cycle of the 32 byte, while fetching the instruction, the jump of the branch instruction is predicted, and the prediction is made according to the high 2 byte of the branch instruction, and if the jump occurs in the predicted branch instruction, then jump to the target address. After retrieving the instruction from the target address, it is necessary to check the instruction alias error, that is, to determine whether the branch instruction that predicts the jump is a branch instruction, and the type of the branch instruction is the same.

Further, in the method, multiple threads are supported, and all threads share the BPU prediction unit, so the prediction information between threads interferes with each other, and the results of interference include:

BPU may take the middle content of an instruction, that is, not the end of the branch instruction, as the end of the branch instruction where the jump occurs.

The type of branch instruction does not match if this BPU information is written by a JA, but when a JALR instruction may predict based on the information of the JAL.

Further, in the method, the BPU information includes a prediction offset pred_offset of the BPU and an instruction type pred_type. The BPU generates a refresh according to the target predicted by the BPU, and refetches the instruction to detect whether the s_mark_end [20] is 1. If not, the position predicted by pred_offset is not the end position of a branch instruction, but the middle of an instruction, then a refresh is generated from the address at the end of the most recent instruction in the pred_offset, and the instruction is refetched, while clearing the incorrect prediction information in the BPU.

Further, in the method, if the pred_offset is the end position of a branch instruction, but when fetching the instruction, it is also determined that the corresponding position of the s_mark_end is a branch instruction. If the type of branch instruction is different from the type pred_type predicted by BPU, it is also an alias error, and there is no error in the instruction that predicts the jump. But if the predicted destination address is incorrect, the instruction is refetched from the position where pred_offset plus 1 is added, and the error message corresponding to that location in the BPU is cleared. Only when the location and type predicted by BPU are correct, the prediction information of BPU is correct, otherwise it is necessary to generate a refresh and retrieve the instruction from the correct address.

Further, in the method, when each instruction has been extracted from the instruction stream, it is determined whether there is a branch instruction in the instruction and whether a jump occurs according to the prediction information of the BPU. In the instruction, if there are multiple branch instructions, the first instruction has the highest priority, followed by the second instruction, and so on, the refresh is generated according to the target address of the branch instruction. Instruction Fetch Unit refetches the instruction according to this new address, and if there is no branch instruction, all instructions are written to the instruction queue.

In a second aspect, the invention discloses a readable storage medium, which includes a memory for storing execution instructions. When the processor executes the execution instruction stored in the memory, the processor hardware executes the parallel extraction instruction method described in the first aspect.

The beneficial effects of the invention are:

The present invention generates a valid vector for extracting instructions according to the end position vector s_mark_end of the instruction, and extracts multiple instructions in parallel through logical “AND” and logical “OR” operations. It can extract multiple instructions in parallel at the same time, there is no serial dependency between each instruction, the timing is easy to converge, and a higher frequency can be obtained. The present invention is particularly suitable for high-performance processors that fetch more than 8 instructions per clock cycle.

### DESCRIPTION OF DRAWINGS

In order to more clearly illustrate the technical scheme in the embodiment of the present invention or the prior art, the drawings that need to be used in the embodiment or the prior art description will be briefly introduced below. It is obvious that the drawings described below are only some embodiments of the invention, and other drawings can be obtained according to these drawings without creative work for those skilled in the art.

FIG. 1 is a schematic diagram of the RISC V instruction mode of the present invention

FIG. 2 is an Instruction Fetch Unit top-level diagram of an embodiment of the present invention.

FIG. 3 is an instruction boundary identification diagram of an embodiment of the present invention.

FIG. 4 is a vector diagram of the instruction end position of the embodiment of the present invention.

FIG. 5 is a diagram of the cross-boundary instruction jump of the embodiment of the present invention.

FIG. 6 is an alias error check diagram of an embodiment of the present invention.

FIG. 7 is a parallel extraction instruction diagram of an embodiment of the present invention.

FIG. 8 is a logic diagram of instruction generation in the second embodiment of the present invention.

FIG. 9 is a diagram of an embodiment of the present invention calculating an instruction address and a branch target address.

FIG. 10 is a cross-boundary instruction diagram of an embodiment of the present invention.

### DETAILED DESCRIPTION

In order to make the purpose, technical scheme and advantages of the embodiment of the invention more clear, the technical scheme in the embodiment of the invention will be described clearly and completely in combination with the drawings in the embodiment of the invention. It is clear that the described embodiments are some embodiments of the present invention but not all embodiments. Based on the embodiments of the invention, all other embodiments obtained by ordinary technicians in the field without creative work fall within the scope of the protection of the invention.

### Embodiment 1

The embodiment is a method of extracting multiple instructions in parallel according to the end position vector s_mark_end of the instruction and extracting the effective vector of the instruction and extracting a plurality of instructions in parallel through the logic “and” and logic OR operation.

The embodiment is not limited to chips such as CPU, GPU, DSP, etc., and is not limited to any instruction set, any implementation process and other conditions.

In order to explain the principle of this method, we mainly take the RISC-V instruction set as an embodiment.

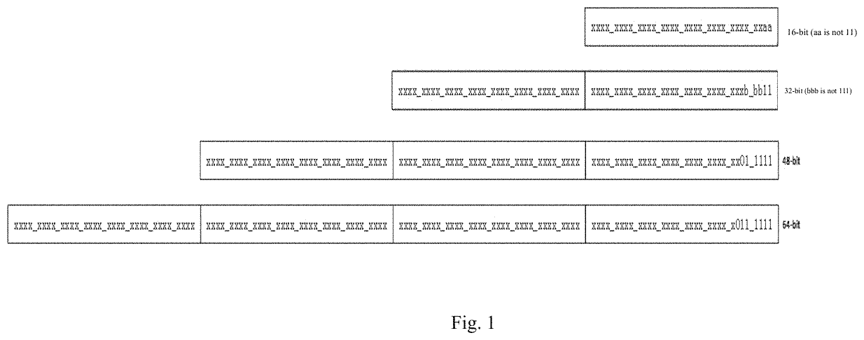

The RISC V instruction set supports 16 bit instruction length, 32 bit instruction length, 32 bit instruction length, 48 bit instruction length and 64 bit instruction length, as shown in FIG. 1. This paper mainly describes the method proposed in this paper by taking instructions with length of 16 bit and 32 bit as embodiments. In order to explain the principle of this method, it is assumed that the instruction bandwidth is 32 byte each time, and 8 instructions are extracted at a time.

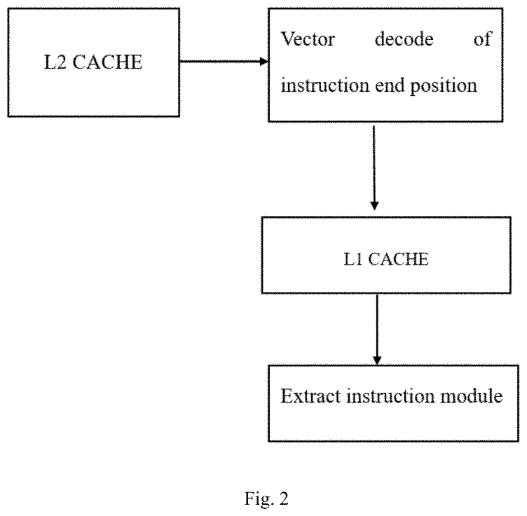

The minimum 2 bit for the 16 bit instruction is 00, 01, or 10. The minimum 2 bit for the 32 bit instruction is 11. Therefore, when judging the length of the current instruction, only the lowest 2 bit of the instruction needs to be judged. First determine the low 2 bit of the first instruction. If the low 2 bit is 00, 01, or 10:00, then the length of the first instruction is 16 bit. If the low 2 bit is 11:00, then the first instruction length is 32 bit. Then the second instruction is judged from the next byte at the end of the instruction. The judgment process is similar to that of the first instruction, and the length of the second instruction can be obtained. And so on, get the length of each instruction in cacheline, as shown in FIG. 2. After getting the length of each instruction, we get the position vector s_end_mark of the end of each instruction in the instruction stream.

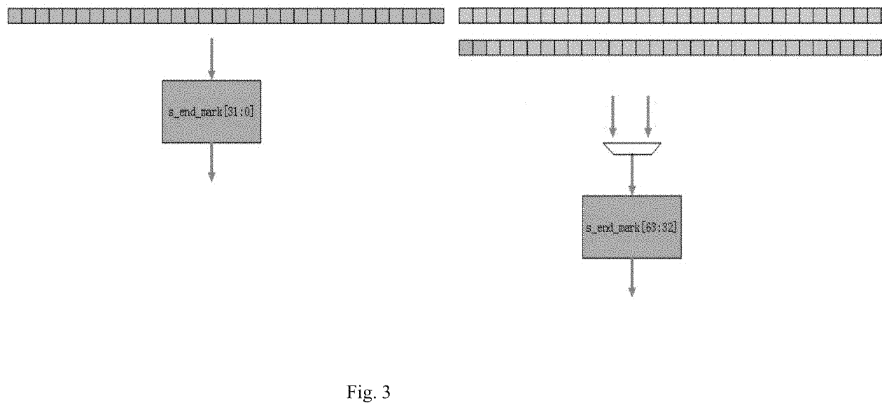

When an instruction is written from L2 to L1, the end position vector s_end_mark of each instruction is calculated. The instruction returned from L2 is in cacheline units. As shown in FIG. 3, each cacheline is 64 byte, and the high and low 32 byte of the instruction calculates the end position vector of the instruction respectively. The high 32 byte instruction speculates that the two instruction end position vectors s_end_mark_0 and s_end_mark_1 with offset 0 and offset 2 are calculated. Select a high 32 byte vector according to the low 32 byte instruction end position vector as the final instruction end vector of the high 32 byte instruction, as shown in FIG. 3. Both the end position vector of the instruction and the instruction are written to L1.

### Embodiment 2

The present embodiment is not limited to chips such as CPU, GPU, DSP, etc., and is not limited to any instruction set, any implementation process and other conditions. This paper mainly takes RISC-V instruction set as an embodiment to illustrate. When Instruction Fetch Unit starts to fetch fingers, when reading instructions in L1 CACHE, the instruction end position vector is read out at the same time to verify the prediction information of BPU and extract instructions.

Instruction end position vector s_mark_end, indicating whether the position is the end of an instruction. A value of 1 indicates the end position of an instruction; a value of 0 indicates that it is not the end position of an instruction, that is, it may be the operation code of the instruction or the immediate number within the instruction.

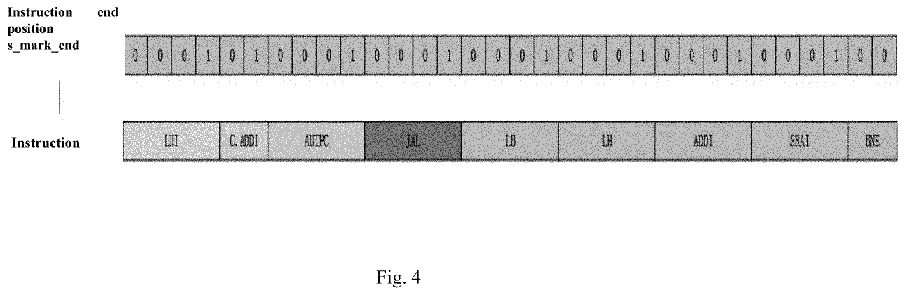

In FIG. 4, the first instruction LUI length is 4 byte, s_mark_end [28] is 1; the second instruction is C.ADDI, which is a compression instruction of 16 bit, s_mark_end [26] is 1; the third instruction AUIPC length is 4 byte, s_mark_end [22] is 1; the fourth instruction JAL length is 4 byte, s_mark_end [18] is 1; the fifth instruction LB length is 4 byte, s_mark_end [14] is 1; the sixth instruction LH length is 4 byte, s_mark_end [10] is 1; the seventh instruction ADDI length is 4 byte, s_mark_end [6] is 1; the eighth instruction SRAI length is 4 byte, s_mark_end [2] is 1; the ninth instruction BNE length is 4 byte, this instruction spans the 32 byte, so the instruction end position of the instruction BNE is not in the current instruction block, as shown in FIG. 4.

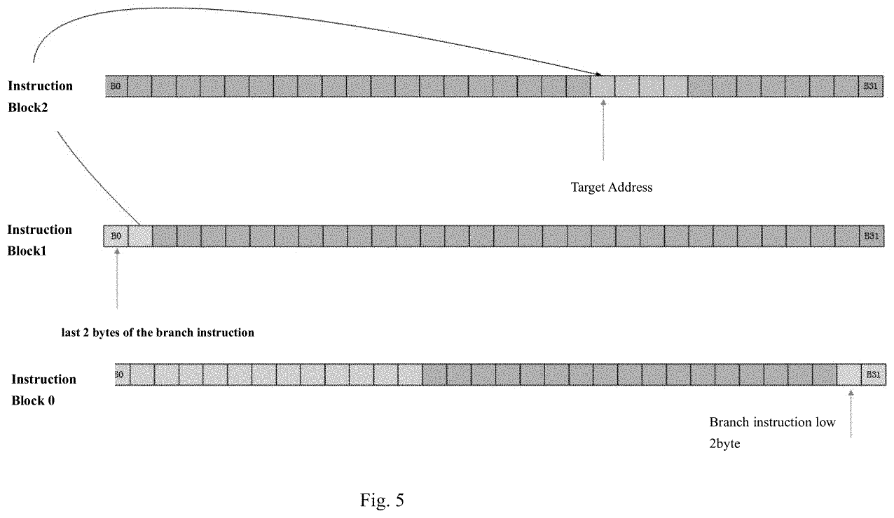

The bandwidth of Instruction Fetch Unit is each clock cycle of 32 byte. Because 16 bit/32 bit hybrid instructions are supported, it is possible for a branch instruction to span two adjacent instruction blocks. The low 2 byte of the branch instruction is at the end of a 32 byte instruction block block0, while the high 2 byte is at the head of the adjacent instruction block block1, as shown in FIG. 5.

While fetching the instruction, the jump of the branch instruction is predicted. The prediction is made according to the high 2 byte of the branch instruction, and if the branch instruction is predicted to jump, it will jump to the target address. After retrieving the instruction from the target address, it is necessary to check the instruction alias error, that is, to determine whether the branch instruction that predicts the jump is a branch instruction, and the type of the branch instruction is the same.

Because multiple threads are supported and all threads share the BPU prediction unit, the prediction information between threads interferes with each other.

The results of interference include: 1 the BPU may take the middle content of an instruction, that is, not the end of the branch instruction, as the end position of the branch instruction where the jump occurs.

2, the type of branch instruction does not match, if this BPU information is written by a JA, but when a JALR instruction may predict based on the information of the JAL.

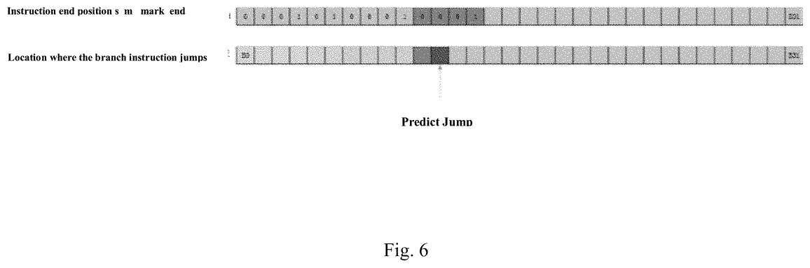

The BPU prediction information includes the prediction offset pred_offset of the BPU and the instruction type pred_type. As shown in FIG. 6, pred_offset is 5′d11, that is, the position in the BPU prediction chart is the end position of a branch instruction, and the jump occurs.

BPU generates a refresh based on the target predicted by BPU and refetches the finger. When fetching the instruction, it is detected whether s_mark_end [20] is 1. It is found that s_mark_end [20] is 0, that is, the position predicted by pred_offset is not the end position of a branch instruction, but the middle of an instruction.

At this point, you need to add 1 from the address at the end of the most recent instruction in pred_offset, generate a refresh, and refetch the instruction, while clearing the wrong prediction information in BPU. By the same token, if pred_offset is the end position of a branch instruction, but when fetching, it is judged that the corresponding position of s_mark_end is a branch instruction, and if the type of branch instruction is different from the type pred_type predicted by BPU, it is also an alias error.

There is no error in predicting the jump of this instruction, but the predicted target address is incorrect. It is necessary to retrieve the instruction from the position where pred_offset plus 1 is added, and clear the error message of the corresponding location in BPU. Only when the location and type predicted by BPU are correct, the prediction information of BPU is correct, otherwise it is necessary to generate a refresh and retrieve the instruction from the correct address.

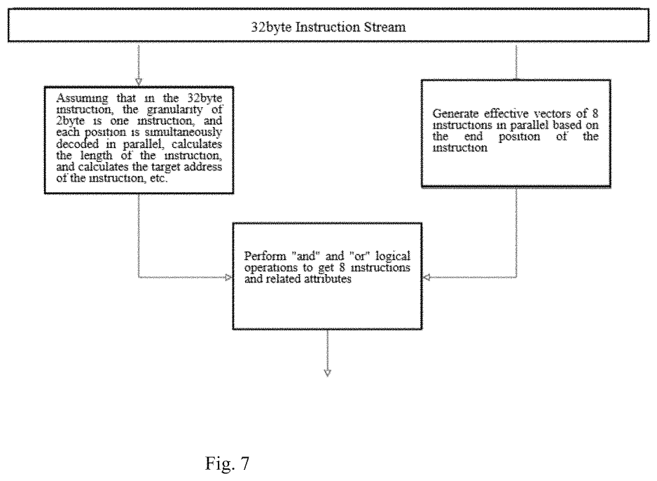

The embodiment parallel generates and extracts eight instruction effective vectors according to the instruction end vector, and at the same time, the 32 byte instruction conjectures the decoding, calculates the instruction address, calculates the target address of the instruction, and so on. Then, perform “AND” and “OR” logical operations on the effective vector of 8 instructions and speculative decoding, calculate the address of the instruction, calculate the target address of the instruction, etc., to obtain the extracted instruction and related attributes, as shown in FIG. 7.

### Embodiment 3

The present embodiment takes the effective vector generation logic of the second instruction as an embodiment. S_prt represents the offset of the first instruction in the 32 byte instruction stream. S_mark_end represents the instruction end position vector in the 32 byte instruction stream, and each bit of s_mark_end is 1 to indicate the end position of an instruction. Inst_2_val represents the valid vector of the second instruction in the 32 byte instruction stream, and the position of 1 indicates the byte at the beginning of the second instruction. Taking the 4 byte from this position is a complete instruction (if it is a compressed instruction of 16 bit, it has also been decoded to an 32 bit instruction). The effective vector inst_2_val of the second instruction and the 16 instructions obtained by speculative decoding first do the “AND” operation, and then do the “OR” operation to get the second instruction.

S_ptr and s_mark_end form an instruction position identification vector of 35 bit, which is mapped to another vector inst_2_val in the form of onehot. The logical mapping relationship that produces the valid vector of the second instruction is shown in the following table:

TABLE 1
Valid vector map of the second instruction

| 2nd instruction position id vector | 2nd instruction position valid vector |
|---|---|
| 00000xxxxxxxxxxxxxxxxxxxxxxxx10001000 | 00000000000000000000000000010000 |
| 00000xxxxxxxxxxxxxxxxxxxxxxxxxx101000 | 00000000000000000000000000010000 |
| 00000xxxxxxxxxxxxxxxxxxxxxxxxxx100010 | 00000000000000000000000000000100 |
| 00000xxxxxxxxxxxxxxxxxxxxxxxxxxxx1010 | 00000000000000000000000000000100 |
| 00010xxxxxxxxxxxxxxxxxxxxxx10001000xx | 00000000000000000000000001000000 |
| 00010xxxxxxxxxxxxxxxxxxxxxxxx101000xx | 00000000000000000000000001000000 |
| 00010xxxxxxxxxxxxxxxxxxxxxxxx100010xx | 00000000000000000000000000010000 |
| 00010xxxxxxxxxxxxxxxxxxxxxxxxxx1010xx | 00000000000000000000000000010000 |
| 00100xxxxxxxxxxxxxxxxxxxx10001000xxxx | 00000000000000000000000100000000 |
| 00100xxxxxxxxxxxxxxxxxxxxxx101000xxxx | 00000000000000000000000100000000 |
| 00100xxxxxxxxxxxxxxxxxxxxxx100010xxxx | 00000000000000000000000001000000 |
| 00100xxxxxxxxxxxxxxxxxxxxxxxx1010xxxx | 00000000000000000000000001000000 |
| 00110xxxxxxxxxxxxxxxxxx10001000xxxxxx | 00000000000000000000010000000000 |
| 00110xxxxxxxxxxxxxxxxxxxx101000xxxxxx | 00000000000000000000010000000000 |
| 00110xxxxxxxxxxxxxxxxxxxx100010xxxxxx | 00000000000000000000000100000000 |
| 00110xxxxxxxxxxxxxxxxxxxxxx1010xxxxxx | 00000000000000000000000100000000 |
| 01000xxxxxxxxxxxxxxxxx10001000xxxxxxx | 00000000000000000000100000000000 |
| 01000xxxxxxxxxxxxxxxxxxx101000xxxxxxx | 00000000000000000000100000000000 |
| 01000xxxxxxxxxxxxxxxxxxx100010xxxxxxx | 00000000000000000000001000000000 |
| 01000xxxxxxxxxxxxxxxxxxxxx1010xxxxxxx | 00000000000000000000001000000000 |
| 01010xxxxxxxxxxxxxx10001000xxxxxxxxxx | 00000000000000000100000000000000 |
| 01010xxxxxxxxxxxxxxxx101000xxxxxxxxxx | 00000000000000000100000000000000 |
| 01010xxxxxxxxxxxxxxxx100010xxxxxxxxxx | 00000000000000000001000000000000 |
| 01010xxxxxxxxxxxxxxxxxx1010xxxxxxxxxx | 00000000000000000001000000000000 |
| 01100xxxxxxxxxxxx10001000xxxxxxxxxxxx | 00000000000000010000000000000000 |
| 01100xxxxxxxxxxxxxx101000xxxxxxxxxxxx | 00000000000000010000000000000000 |
| 01100xxxxxxxxxxxxxx100010xxxxxxxxxxxx | 00000000000000000100000000000000 |
| 01100xxxxxxxxxxxxxxxx1010xxxxxxxxxxxx | 00000000000000000100000000000000 |
| 01110xxxxxxxxxx10001000xxxxxxxxxxxxxx | 00000000000001000000000000000000 |
| 01110xxxxxxxxxxxx101000xxxxxxxxxxxxxx | 00000000000001000000000000000000 |
| 01110xxxxxxxxxxxx100010xxxxxxxxxxxxxx | 00000000000000010000000000000000 |
| 01110xxxxxxxxxxxxxx1010xxxxxxxxxxxxxx | 00000000000000010000000000000000 |
| 10000xxxxxxxx10001000xxxxxxxxxxxxxxxx | 00000000000100000000000000000000 |
| 10000xxxxxxxxxx101000xxxxxxxxxxxxxxxx | 00000000000100000000000000000000 |
| 10000xxxxxxxxxx100010xxxxxxxxxxxxxxxx | 00000000000001000000000000000000 |
| 10000xxxxxxxxxxxx1010xxxxxxxxxxxxxxxx | 00000000000001000000000000000000 |
| 10010xxxxxx10001000xxxxxxxxxxxxxxxxxx | 00000000010000000000000000000000 |
| 10010xxxxxxxx101000xxxxxxxxxxxxxxxxxx | 00000000010000000000000000000000 |
| 10010xxxxxxxx100010xxxxxxxxxxxxxxxxxx | 00000000000100000000000000000000 |
| 10010xxxxxxxxxx1010xxxxxxxxxxxxxxxxxx | 00000000000100000000000000000000 |
| 10100xxxx10001000xxxxxxxxxxxxxxxxxxxx | 00000001000000000000000000000000 |
| 10100xxxxxx101000xxxxxxxxxxxxxxxxxxxx | 00000001000000000000000000000000 |
| 10100xxxxxx100010xxxxxxxxxxxxxxxxxxxx | 00000000010000000000000000000000 |
| 10100xxxxxxxx1010xxxxxxxxxxxxxxxxxxxx | 00000000010000000000000000000000 |
| 10110xx10001000xxxxxxxxxxxxxxxxxxxxxx | 00000100000000000000000000000000 |
| 10110xxxx101000xxxxxxxxxxxxxxxxxxxxxx | 00000100000000000000000000000000 |
| 10110xxxx100010xxxxxxxxxxxxxxxxxxxxxx | 00000001000000000000000000000000 |
| 10110xxxxxx1010xxxxxxxxxxxxxxxxxxxxxx | 00000001000000000000000000000000 |
| 1100010001000xxxxxxxxxxxxxxxxxxxxxxxx | 00010000000000000000000000000000 |
| 11000xx101000xxxxxxxxxxxxxxxxxxxxxxxx | 00010000000000000000000000000000 |
| 11000xx100010xxxxxxxxxxxxxxxxxxxxxxxx | 00000100000000000000000000000000 |
| 11000xxxx1010xxxxxxxxxxxxxxxxxxxxxxxx | 00000100000000000000000000000000 |
| 11010101000xxxxxxxxxxxxxxxxxxxxxxxxxx | 01000000000000000000000000000000 |
| 11010100010xxxxxxxxxxxxxxxxxxxxxxxxxx | 00010000000000000000000000000000 |
| 11010xx1010xxxxxxxxxxxxxxxxxxxxxxxxxx | 00010000000000000000000000000000 |
| 111001010xxxxxxxxxxxxxxxxxxxxxxxxxxxx | 01000000000000000000000000000000 |
| 00000xxxxxxxxxxxxxxxxxxxxxxxx10001000 | 00000000000000000000000000010000 |
| 00000xxxxxxxxxxxxxxxxxxxxxxxxxx101000 | 00000000000000000000000000010000 |
| 00000xxxxxxxxxxxxxxxxxxxxxxxxxx100010 | 00000000000000000000000000000100 |
| 00000xxxxxxxxxxxxxxxxxxxxxxxxxxxx1010 | 00000000000000000000000000000100 |
| 00010xxxxxxxxxxxxxxxxxxxxxx10001000xx | 00000000000000000000000001000000 |
| 00010xxxxxxxxxxxxxxxxxxxxxxxx101000xx | 00000000000000000000000001000000 |
| 00010xxxxxxxxxxxxxxxxxxxxxxxx100010xx | 00000000000000000000000000010000 |
| 00010xxxxxxxxxxxxxxxxxxxxxxxxxx1010xx | 00000000000000000000000000010000 |
| 00100xxxxxxxxxxxxxxxxxxxx10001000xxxx | 00000000000000000000000100000000 |
| 00100xxxxxxxxxxxxxxxxxxxxxx101000xxxx | 00000000000000000000000100000000 |
| 00100xxxxxxxxxxxxxxxxxxxxxx100010xxxx | 00000000000000000000000001000000 |
| 00100xxxxxxxxxxxxxxxxxxxxxxxx1010xxxx | 00000000000000000000000001000000 |
| 00110xxxxxxxxxxxxxxxxxx10001000xxxxxx | 00000000000000000000010000000000 |
| 00110xxxxxxxxxxxxxxxxxxxx101000xxxxxx | 00000000000000000000010000000000 |
| 00110xxxxxxxxxxxxxxxxxxxx100010xxxxxx | 00000000000000000000000100000000 |
| 00110xxxxxxxxxxxxxxxxxxxxxx1010xxxxxx | 00000000000000000000000100000000 |
| 01000xxxxxxxxxxxxxxxxx10001000xxxxxxx | 00000000000000000000100000000000 |
| 01000xxxxxxxxxxxxxxxxxxx101000xxxxxxx | 00000000000000000000100000000000 |
| 01000xxxxxxxxxxxxxxxxxxx100010xxxxxxx | 00000000000000000000001000000000 |
| 01000xxxxxxxxxxxxxxxxxxxxx1010xxxxxxx | 00000000000000000000001000000000 |
| 01011xxxxxxxxxxxxxx10001000xxxxxxxxxx | 00000000000000000100000000000000 |
| 01010xxxxxxxxxxxxxxxx101000xxxxxxxxxx | 00000000000000000100000000000000 |
| 01010xxxxxxxxxxxxxxxx100010xxxxxxxxxx | 00000000000000000001000000000000 |
| 01010xxxxxxxxxxxxxxxxxx1010xxxxxxxxxx | 00000000000000000001000000000000 |
| 01100xxxxxxxxxxxx10001000xxxxxxxxxxxx | 00000000000000010000000000000000 |
| 01100xxxxxxxxxxxxxx101000xxxxxxxxxxxx | 00000000000000010000000000000000 |
| 01100xxxxxxxxxxxxxx100010xxxxxxxxxxxx | 00000000000000000100000000000000 |
| 01100xxxxxxxxxxxxxxxx1010xxxxxxxxxxxx | 00000000000000000100000000000000 |
| 01110xxxxxxxxxx10001000xxxxxxxxxxxxxx | 00000000000001000000000000000000 |
| 01110xxxxxxxxxxxx101000xxxxxxxxxxxxxx | 00000000000001000000000000000000 |
| 01110xxxxxxxxxxxx100010xxxxxxxxxxxxxx | 00000000000000010000000000000000 |
| 01110xxxxxxxxxxxxxx1010xxxxxxxxxxxxxx | 00000000000000010000000000000000 |
| 10000xxxxxxxx10001000xxxxxxxxxxxxxxxx | 00000000000100000000000000000000 |
| 10000xxxxxxxxxx101000xxxxxxxxxxxxxxxx | 00000000000100000000000000000000 |
| 10000xxxxxxxxxx100010xxxxxxxxxxxxxxxx | 00000000000001000000000000000000 |
| 10000xxxxxxxxxxxx1010xxxxxxxxxxxxxxxx | 00000000000001000000000000000000 |
| 10010xxxxxx10001000xxxxxxxxxxxxxxxxxx | 00000000010000000000000000000000 |
| 10010xxxxxxxx101000xxxxxxxxxxxxxxxxxx | 00000000010000000000000000000000 |
| 10010xxxxxxxx100010xxxxxxxxxxxxxxxxxx | 00000000000100000000000000000000 |
| 10010xxxxxxxxxx1010xxxxxxxxxxxxxxxxxx | 00000000000100000000000000000000 |
| 10100xxxx10001000xxxxxxxxxxxxxxxxxxxx | 00000001000000000000000000000000 |
| 10100xxxxxx101000xxxxxxxxxxxxxxxxxxxx | 00000001000000000000000000000000 |
| 10100xxxxxx100010xxxxxxxxxxxxxxxxxxxx | 00000000010000000000000000000000 |
| 10100xxxxxxxx1010xxxxxxxxxxxxxxxxxxxx | 00000000010000000000000000000000 |
| 10110xx10001000xxxxxxxxxxxxxxxxxxxxxx | 00000100000000000000000000000000 |
| 10110xxxx101000xxxxxxxxxxxxxxxxxxxxxx | 00000100000000000000000000000000 |
| 10110xxxx100010xxxxxxxxxxxxxxxxxxxxxx | 00000001000000000000000000000000 |
| 10110xxxxxx1010xxxxxxxxxxxxxxxxxxxxxx | 00000001000000000000000000000000 |
| 1100010001000xxxxxxxxxxxxxxxxxxxxxxxx | 00010000000000000000000000000000 |
| 11000xx101000xxxxxxxxxxxxxxxxxxxxxxxx | 00010000000000000000000000000000 |
| 11000xx100010xxxxxxxxxxxxxxxxxxxxxxxx | 00000100000000000000000000000000 |
| 11000xxxx1010xxxxxxxxxxxxxxxxxxxxxxxx | 00000100000000000000000000000000 |
| 11010101000xxxxxxxxxxxxxxxxxxxxxxxxxx | 01000000000000000000000000000000 |
| 11010100010xxxxxxxxxxxxxxxxxxxxxxxxxx | 00010000000000000000000000000000 |
| 11010xx1010xxxxxxxxxxxxxxxxxxxxxxxxxx | 00010000000000000000000000000000 |
| 111001010xxxxxxxxxxxxxxxxxxxxxxxxxxxx | 01000000000000000000000000000000 |

In the same way, the effective vectors of the remaining instructions can be obtained.

The instruction fetch unit decodes 32 bytes each time, and the RISC-V instruction length is 2 or 4. So the opcodes for instructions start at the even-numbered positions 0, 2, 4, . . . 30. Similarly, the end position of the instruction is odd-numbered positions 1, 3, 5, . . . , 31.

The effective vector inst_2_val[0] for the instruction is 1 if the instruction starts at position 0. At the same time, the instruction inst0 obtained by speculative decoding is fetched, and the length is 4 bytes. When the instruction is a C extension instruction, it has been decoded into an instruction with a length of 4 bytes during speculative decoding.

If the instruction starts from position 2, the effective vector inst_2_val[2] of the instruction is 1; meanwhile, the instruction inst1 obtained by speculative decoding is fetched.

If the instruction starts from position 4, then the effective vector inst_2_val[4] of the instruction is 1; meanwhile, the instruction inst2 obtained by speculative decoding is fetched.

If the instruction starts from position 6, then the effective vector inst_2_val[6] of the instruction is 1; meanwhile, the instruction inst3 obtained by speculative decoding is fetched.

If the instruction starts from position 8, the effective vector inst_2_val[8] of the instruction is 1; meanwhile, the instruction inst4 obtained by speculative decoding is fetched.

If the instruction starts from position 10, the effective vector inst_2_val[10] of the instruction is 1; meanwhile, the instruction inst5 obtained by speculative decoding is fetched.

If the instruction starts from position 12, the effective vector inst_2_val[12] of the instruction is 1; meanwhile, the instruction inst6 obtained by speculative decoding is fetched.

If the instruction starts from position 14, the effective vector inst_2_val[14] of the instruction is 1; meanwhile, the instruction inst7 obtained by speculative decoding is fetched.

If the instruction starts from position 16, then the effective vector inst_2_val[16] of the instruction is 1; meanwhile, the instruction inst8 obtained by speculative decoding is fetched.

If the instruction starts from position 18, the effective vector inst_2_val[18] of the instruction is 1; meanwhile, the instruction inst9 obtained by speculative decoding is fetched.

If the instruction starts from position 20, the effective vector inst_2_val[20] of the instruction is 1; meanwhile, the instruction inst10 obtained by speculative decoding is fetched.

If the instruction starts from position 22, the effective vector inst_2_val[22] of the instruction is 1; meanwhile, the instruction inst11 obtained by speculative decoding is fetched.

If the instruction starts from position 24, then the effective vector inst_2_val[24] of the instruction is 1; meanwhile, the instruction inst12 obtained by speculative decoding is fetched.

If the instruction starts from position 26, the effective vector inst_2_val[26] of the instruction is 1; meanwhile, the instruction inst13 obtained by speculative decoding is fetched.

If the instruction starts from position 28, the effective vector inst_2_val[28] of the instruction is 1; meanwhile, the instruction inst14 obtained by speculative decoding is fetched.

If the instruction starts from position 30, if the current instruction does not cross the boundary, then the effective vector inst_2_val[30] of the instruction is 1; meanwhile, the instruction inst15 obtained by speculative decoding is fetched.

If the current instruction crosses the boundary, the current instruction is invalid, and this instruction is not fetched until the next 32 byte instruction stream is valid.

If the offset of the 1st instruction is not 0, it starts at a non-zero offset. Then the starting position of the 1st instruction is the position of this offset. The positions of other instructions start with the same offset in sequence.

The logical expression to get the second instruction is:

### Inst_2=({32{inst_2_val[0]}}&inst0|

({32{inst_2_val[2]}}&inst1)|
({32{inst_2_val[4]}}&inst2)|
({32{inst_2_val[6]}}&inst3)|
({32{inst_2_val[8]}}&inst4)|
({32{inst_2_val[10]}}&inst5)|
({32{inst_2_val[12]}}&inst6)|
({32{inst_2_val[14]}}&inst7)|
({32{inst_2_val[16]}}&inst8)|
({32{inst_2_val[18]}}&inst9)|
({32{inst_2_val[20]}}&inst10)|
({32{inst_2_val[22]}}&inst11)|
({32{inst_2_val[24]}}&inst12)|
({32{inst_2_val[26]}}&inst13)|
({32{inst_2_val[28]}}&inst14)|
   ({32{inst_2_val[30]}}&inst15));

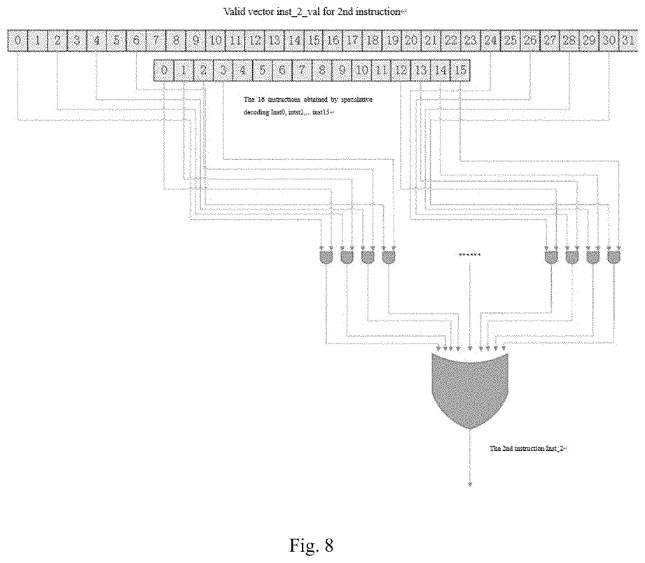

Inst0, inst1, . . . inst15 are 16 speculatively generated instructions. The circuit implemented by the second instruction is implemented by logic “AND” and logic “OR” gates, as shown in FIG. 8. Other instructions, according to the same principle, can obtain logical expressions and logical circuit diagrams.

### Embodiment 4

When calculating the address and target address of an instruction in this embodiment, it is also speculative calculation. The Instruction Fetch Unit fetches 32 bytes each time, and the fetch address is fetch_address, which is the base address for calculating the instruction address. Because the length of the RISC V instruction is 2 or 4, the instruction addresses for the speculative calculation of the 16 positions are: base_address, base_address+2, base_address+4, base_address+8, base_address+10, base_address+12, base_address+14, base_address+16, base_address+18, base_address+20, base_address+22, base_address+24, base_address+28 and base_address+30. The address inst_2_addr of the second instruction is also obtained using the logic similar to the second instruction. As follows:

Inst_2_addr=({64{inst_2_val[0]}}& base_address)|
({64{inst_2_val[2]}}&(base_address+2))|
({64{inst_2_val[4]}}&(base_address+4))|
({64{inst_2_val[6]}}&(base_address+6))|
({64{inst_2_val[8]}}&(base_address+8))|
({64{inst_2_val[10]}}&(base_address+10))|
({64{inst_2_val[12]}}&(base_address+12))|
({64{inst_2_val[14]}}&(base_address+14))|
({64{inst_2_val[16]}}&(base_address+16))|
({64{inst_2_val[18]}}&(base_address+18))|
({64{inst_2_val[20]}}&(base_address+20))|
({64{inst_2_val[22]}}&(base_address+22))|
({64{inst_2_val[24]}}&(base_address+24))|
({64{inst_2_val[26]}}&(base_address+26))|
({64{inst_2_val[28]}}&(base_address+28))|
({64{inst_2_val[30]}}&(base_address+30)));

Instructions fetched in the Instruction Fetch Unit, the branch instructions in the instructions include JAL, JALR, BEQ, BNE, BLT, BGE, BLTU, BGEU, C.JAL, CJ, C.BEQZ, C.BNEZ, C.JR and C. JALR. Among them, the destination address of the instructions JAL, BEQ, BNE, BLT, BGE, BLTU, BGEU, C.JAL, C.J, C.BEQZ, C.BNEZ is the addition of the instruction address and the offset. Similarly, it is assumed that each offset of 2 byte is a branch instruction, so it is also speculated that the target address of each instruction can be obtained by parallel computation. It is speculated that the target addresses of the instructions at 16 locations are: base_address+offset, base_address+2+offset, base_address+4+offset, base_address+8+offset, base_address+10+offset, base_address+12+offset, base_address+14+offset, base_address+16+offset, base_address+18+offset, base_address+20+offset, base_address+22+offset, base_address+24+offse, base_address+28+offset and base_address+30+offset. Offset is the offset of the branch instruction. Inst is an instruction.

The conditional instruction immediate number cond_imm of the 32 bit instruction is: cond_imm: {inst[31], inst[7], inst[30:25], inst[11:8], 1′b0};

The immediate data of unconditional instruction of 32 bit instruction is: uncond_imm: {inst[31], inst[19:12], inst[20], inst[30:21], 1′b0};

The conditional instruction immediate number cond_imm_c of the 16 bit compressed instruction is: cond_imm_c: {inst[12], inst[6:5], inst[2], inst[11:10], inst[4:3], 1′b0};

The unconditional instruction immediate number uncond_imm_c of the 16 bit compressed instruction is: uncond_imm_c: {inst[12], inst[8], inst[10:9], inst[6], inst[7], inst[2], inst[11], inst[5:3], 1′b0};

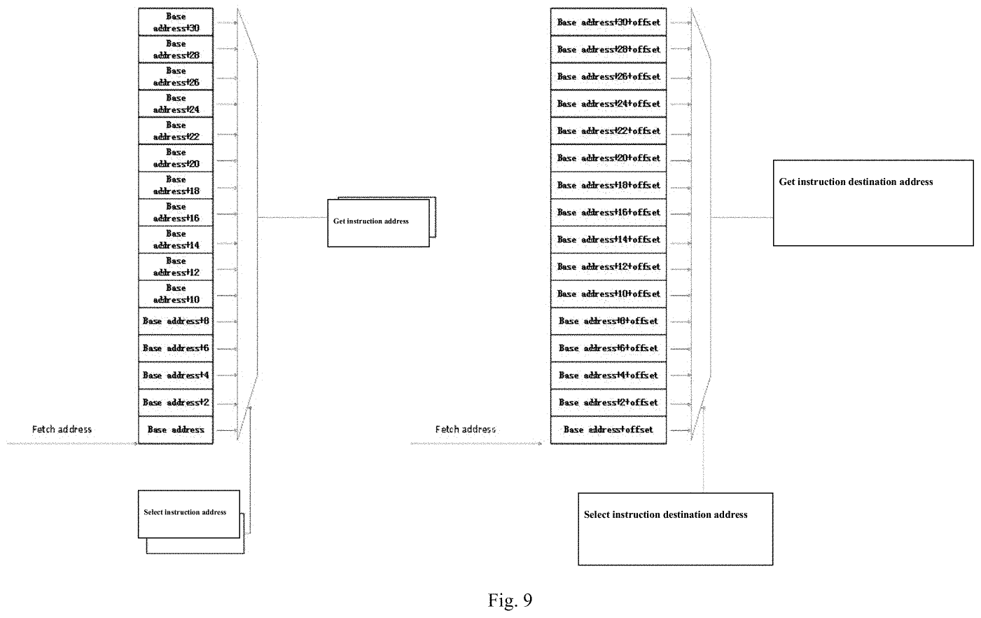

Each location may be these four branch instructions, so each location first determines the instruction type, and then calculates a different type of offset offset. The target address of the second instruction, Inst_2_target_addr, can also get a logical expression similar to Inst_2_addr, as shown in FIG. 9.

### Embodiment 5

The present embodiment determines that a specific branch instruction type br_type for each location is obtained. Br_type [0] is the conditional instruction of 32 bit instruction, br_type [1] is the unconditional instruction of 32 bit instruction, br_type [2] is the conditional instruction of 16 bit instruction, and br_type [3] is the unconditional instruction of 16 bit instruction. Therefore, the offset offset of the branch instruction is obtained according to br_type and cond_imm, uncond_imm, cond_imm_c and uncond_imm_c.

Since both 16 bit and 32 bit instructions are supported, there are mixed 16 bit and 32 bit instructions in the instruction stream. Each 32 byte instruction consists of 8-16 instructions, so an 32 bit instruction may exist across consecutive adjacent 32 byte instruction streams. In the instruction extraction module, a 2 byte register is used to store the high 2 byte of the 32 byte instruction stream, and the 2 byte is used as the 2 byte of cross-boundary instructions.

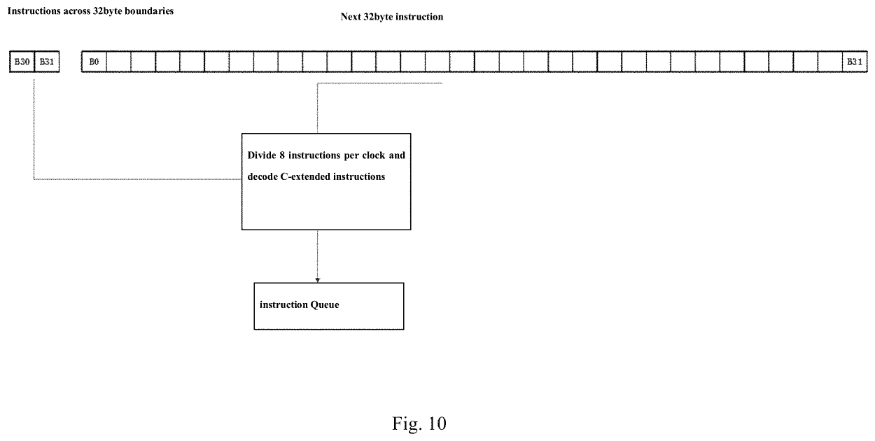

At the same time, it is determined whether the cross-boundary instruction occurs in the current 32 byte instruction stream, and if so, it is necessary to generate a valid indication signal of the cross-boundary instruction. When the adjacent 32 byte instruction blocks reach the instruction fetch pipeline stage, if the cross-boundary instruction effectively indicates that the signal is 1, it indicates that the first instruction has a cross-boundary situation. At this point, the first instruction consists of two parts, as shown in FIG. 10.

If the cross-boundary instruction effectively indicates that the signal is 0, it means that the first instruction does not cross the boundary. The first instruction is the first instruction of the current 32 byte instruction block. Other instructions are taken in turn from the subsequent instruction stream of the first instruction. When the instruction is a branch instruction across the boundary, the BPU prediction information of the instruction also needs to be saved until the adjacent instruction stream is valid, the prediction information of the first instruction is obtained, which is similar to the processing method of getting the first instruction.

When each instruction has been extracted from the instruction stream, it is judged whether there are branch instructions in the 8 instructions and whether the jump occurs according to the prediction information of the BPU. Among the 8 instructions, if there are multiple branch instructions, the first instruction has the highest priority, followed by the second instruction, and so on. A refresh is generated according to the target address of the branch instruction, and the Instruction Fetch Unit refetches the instruction according to this new address. If there are no branch instructions, all instructions are written to the instruction queue.

### Embodiment 6

The present embodiment discloses a readable storage medium, including a memory for storing execution instructions. When the processor executes the execution instruction stored in the memory, the processor hardware executes a method of extracting instructions in parallel.

In summary, according to the end position vector s_mark_end of the instruction, the invention generates a method of extracting the effective vector of the instruction and extracting a plurality of instructions in parallel through the logic “and” and logic OR operation. Multiple instructions can be extracted in parallel at the same time, there is no serial dependency between each instruction, the timing is easy to converge, and a higher main frequency can be obtained. It is especially suitable for high-performance processors that extract more than 8 instructions per clock cycle.

The above embodiments are only used to illustrate the technical scheme of the present invention and not to restrict it. Although the invention is explained in detail with reference to the above-mentioned embodiments, ordinary technicians in the field should understand that it can still modify the technical scheme recorded in the above-mentioned embodiments, or equivalent replacement of some of the technical features; and these modifications or replacements do not deviate the essence of the corresponding technical scheme from the spirit and scope of the technical scheme of the embodiments of the present invention.

1-10. (canceled)

11. A method for extracting instructions in parallel, comprising:
generating an effective vector of extracting instructions according to an end position vector s_end_mark of the instructions;
carrying out parallel decoding of instructions at each position through logical “AND” and logical “OR” operations;
computing instruction addresses and branch instruction target addresses; and
extracting multiple instructions in parallel.

12. The method according to claim 11, wherein for each instruction of the instructions including a first instruction and a second instruction, an instruction length of the instruction is determined based on a low 2 bit of the respective instruction, wherein:
if the low 2 bit is 00, 01, or 10:00, the instruction length is 16 bits;
if the low 2 bit is 11:00, the instruction length is 32 bit; and
wherein the second or next instruction is determined from a next byte at an end position of the current instruction;
after obtaining the length of each instruction, obtaining the end position vector s_end_mark of each instruction in an instruction stream.

13. The method according to claim 11, wherein:
when writing an instruction by a writer, the end position vector s_end_mark of each instruction is calculated, and the instruction returned from the writer is in a unit of cacheline, and each cacheline is 64 byte;
a high and low 32 byte of the instruction calculates the end position vector of the instruction respectively;
the high 32 byte instruction speculates that the instruction end position vectors s_end_mark_0 and s_end_mark_1 with offset 0 and offset 2 are calculated;
according to the low 32 byte instruction end position vector, a high 32 byte vector is selected as a final instruction end vector of the high 32 byte instruction; and
the instruction end position vector and the instruction are written at the same time.

14. The method according to claim 11, wherein:
when an Instruction Fetch Unit starts to fetch an instruction, the instruction end position vector is read at the same time to verify prediction information of a BPU and extract the instruction;
the instruction end position vector s_end_mark indicates whether a position is the end of an instruction,
a value of 1 indicates that the position is the end position of an instruction, and
a value of 0 indicates that the position is not the end position of an instruction.

15. The method according to claim 14, wherein:
a bandwidth of the Instruction Fetch Unit is 32 byte each clock cycle, while fetching the instruction, a jump of a branch instruction is predicted, and the prediction is carried out according to a high 2 byte of the branch instruction; if the jump occurs in the predicted branch instruction, it jumps to the target address; and
after retrieving the instruction from the target address, checking an instruction alias error by determining whether the branch instruction that predicts the jump is a branch instruction, and the type of the branch instruction is the same.

16. The method according to claim 11, wherein multiple threads are supported, and all threads share a BPU prediction unit, so prediction information between threads interferes with each other, and interference results include:
a BPU takes a middle content of an instruction, but not an end of a branch instruction, as an end position of the branch instruction where a jump occurs; and
a type of a branch instruction does not match if BPU information is written by a JA, but when a JALR instruction predicts based on information of the JAL.

17. The method according to claim 16, wherein:
the BPU information includes a prediction offset pred_offset of the BPU and an instruction type pred_type;
the BPU generates a refresh according to a target predicted by the BPU, and re-fetches the instruction to detect whether s_end_mark [20] is 1; and
if not, a position predicted by pred_offset is not the end position of a branch instruction, but the middle of an instruction, then a refresh is generated from the address at the end position of the most recent instruction in the pred_offset, and the instruction is re-fetched, while clearing incorrect prediction information in the BPU.

18. The method according to claim 11, wherein,
if a pred_offset is the end position of a branch instruction, but when fetching the instruction, it is also determined that a corresponding position of the s_end_mark is a branch instruction;
if a type of branch instruction is different from a type pred_type predicted by a BPU, it is also an alias error, and there is no error in the instruction that predicts a jump;
if a predicted destination address is incorrect, the instruction is re-fetched from the position where pred_offset plus 1 is added, and an error message corresponding to that location in the BPU is cleared; and
only when the location and type predicted by the BPU are correct, the prediction information of BPU is correct, otherwise generating a refresh and retrieving the instruction from the correct address.

19. The method according to claim 11, wherein:
when each instruction has been extracted from an instruction stream, it is determined whether there is a branch instruction in the instruction and whether a jump occurs according to prediction information of a BPU;
in the instruction, if there are multiple branch instructions, the first instruction has a highest priority, followed by the second instruction, and so on, a refresh is generated according to the target address of the branch instruction, and the Instruction Fetch Unit re-fetches the instruction according to the refreshed target address; and
if there are no branch instructions, all instructions are written to the instruction queue.

20. A non-transitory computer readable storage medium including a memory for storing execution instructions, and when a processor executes the execution instructions stored in the memory, the processor executes a method for extracting instructions in parallel, the method comprising:
generating an effective vector of extracting instructions according to an end position vector s_end_mark of the instructions;
carrying out parallel decoding of instructions at each position through logical “AND” and logical “OR” operations;
computing instruction addresses and branch instruction target addresses; and
extracting multiple instructions in parallel.

21. The computer readable storage medium according to claim 20, wherein for each instruction of the instructions including a first instruction and a second instruction, an instruction length of the instruction is determined based on a low 2 bit of the respective instruction, wherein:
if the low 2 bit is 00, 01, or 10:00, the instruction length is 16 bits;
if the low 2 bit is 11:00, the instruction length is 32 bit; and
wherein the second or next instruction is determined from a next byte at an end position of the current instruction;
after obtaining the length of each instruction, obtaining the end position vector s_end_mark of each instruction in an instruction stream.

22. The computer readable storage medium according to claim 20, wherein:
when writing an instruction by a writer, the end position vector s_end_mark of each instruction is calculated, and the instruction returned from the writer is in a unit of cacheline, and each cacheline is 64 byte;
a high and low 32 byte of the instruction calculates the end position vector of the instruction respectively;
the high 32 byte instruction speculates that the instruction end position vectors s_end_mark _0 and s_end_mark_1 with offset 0 and offset 2 are calculated;
according to the low 32 byte instruction end position vector, a high 32 byte vector is selected as a final instruction end vector of the high 32 byte instruction; and
the instruction end position vector and the instruction are written at the same time.

23. The computer readable storage medium according to claim 20, wherein:
when an Instruction Fetch Unit starts to fetch an instruction, the instruction end position vector is read at the same time to verify prediction information of a BPU and extract the instruction;
the instruction end position vector s_end_mark indicates whether a position is the end of an instruction,
a value of 1 indicates that the position is the end position of an instruction, and
a value of 0 indicates that the position is not the end position of an instruction.

24. The computer readable storage medium according to claim 23, wherein:
a bandwidth of the Instruction Fetch Unit is 32 byte each clock cycle, while fetching the instruction, a jump of a branch instruction is predicted, and the prediction is carried out according to a high 2 byte of the branch instruction;
if the jump occurs in the predicted branch instruction, it jumps to the target address; and
after retrieving the instruction from the target address, checking an instruction alias error by determining whether the branch instruction that predicts the jump is a branch instruction, and the type of the branch instruction is the same.

25. The computer readable storage medium according to claim 20, wherein multiple threads are supported, and all threads share a BPU prediction unit, so prediction information between threads interferes with each other, and interference results include:
a BPU takes a middle content of an instruction, but not an end of a branch instruction, as an end position of the branch instruction where a jump occurs; and
a type of a branch instruction does not match if BPU information is written by a JA, but when a JALR instruction predicts based on information of the JAL.

26. The computer readable storage medium according to claim 25, wherein:
the BPU information includes a prediction offset pred_offset of the BPU and an instruction type pred_type;
the BPU generates a refresh according to a target predicted by the BPU, and re-fetches the instruction to detect whether s_end_mark [20] is 1; and
if not, a position predicted by pred_offset is not the end position of a branch instruction, but the middle of an instruction, then a refresh is generated from the address at the end position of the most recent instruction in the pred_offset, and the instruction is re-fetched, while clearing incorrect prediction information in the BPU.

27. The computer readable storage medium according to claim 20, wherein,
if a pred_offset is the end position of a branch instruction, but when fetching the instruction, it is also determined that a corresponding position of the s_end_mark is a branch instruction;
if a type of branch instruction is different from a type pred_type predicted by a BPU, it is also an alias error, and there is no error in the instruction that predicts a jump;
if a predicted destination address is incorrect, the instruction is re-fetched from the position where pred_offset plus 1 is added, and an error message corresponding to that location in the BPU is cleared; and
only when the location and type predicted by the BPU are correct, the prediction information of BPU is correct, otherwise generating a refresh and retrieving the instruction from the correct address.

28. The computer readable storage medium according to claim 20, wherein:
when each instruction has been extracted from an instruction stream, it is determined whether there is a branch instruction in the instruction and whether a jump occurs according to prediction information of a BPU;
in the instruction, if there are multiple branch instructions, the first instruction has a highest priority, followed by the second instruction, and so on, a refresh is generated according to the target address of the branch instruction, and the Instruction Fetch Unit re-fetches the instruction according to the refreshed target address; and
if there are no branch instructions, all instructions are written to the instruction queue.
